(19) United States
(12) Patent Application Publication
(10) Pub. No.: US 2004/0147711 A1
(43) Pub. Date: Jul. 29, 2004

(54) Epoxy resin compositions, methods of preparing, and articles made therefrom

(76) Inventors: Walter H. Christiansen, Houston, TX (US); Larry S. Corley, Houston, TX (US)

Correspondence Address: RESOLUTION PERFORMANCE PRODUCTS LLC, ATTN: LISA JONES, 1600 SMITH STREET, P.O. BOX 4500, HOUSTON, TX, 77210-4500, US

(21) Appl. No.: 10/349,673

(22) Filed: Jan. 23, 2003

(51) Int. Cl. C08G 59/68

(52) U.S. Cl. 528/91

(57) ABSTRACT

Epoxy resin compositions including a boron atom containing compound, and preferably a multiple boron atom containing compound, are disclosed. The resin compositions exhibit enhanced properties such as cure time and glass transition temperature “Tg” and are particular suited to be utilized in the manufacture of composites, especially prepregs used for the manufacture of composite structures.

### FIELD OF THE INVENTION

The present invention relates to epoxy resin compositions, to methods of preparing these epoxy resin compositions and to articles made therefrom. Specifically, the invention relates to epoxy resin compositions that include a boron atom containing compound, and preferably a multiple boron atom containing compound, which have enhanced properties such as cure time and glass transition temperature “Tg”. The resins are particularly suited to be utilized in the manufacture of composites, and especially prepregs used for the fabrication of composite structures.

### BACKGROUND OF THE INVENTION

Prepregs are generally manufactured by impregnating a thermosettable epoxy resin composition into a porous substrate, such as a glass fiber mat, followed by processing at elevated temperatures to promote a partial cure of the epoxy resin in the mat to a “B-stage.” Laminates, and particularly structural and electrical copper clad laminates, are generally manufactured by pressing, under elevated temperatures and pressures, various layers of partially cured prepregs and optionally copper sheeting. Complete cure of the epoxy resin impregnated in the glass fiber mat typically occurs during the lamination step when the prepreg layers are pressed under high pressure and elevated temperatures for a time sufficient to allow for complete cure of the resin.

Epoxy resin systems having a high Tg are desirable in the manufacture of prepregs and laminates. Such systems offer improved heat resistance and reduced thermal expansion required for complex printed circuit board circuitry and for higher fabrication and usage temperatures. Higher Tg values are typically achieved by using multifunctional resins to increase the polymer crosslink density, resins with fused rings to increase polymer background stiffness, or resins with bulky side groups to inhibit molecular rotation about the polymer chains. However, such systems are typically more expensive to formulate and suffer from inferior performance capabilities.

Tg, as used herein, refers to the glass transition temperature of the thermosettable resin system in its current cure state. As the prepreg is exposed to heat, the resin undergoes further cure and its Tg increases, requiring a corresponding increase in the curing temperature to which the prepreg is exposed. The ultimate, or maximum, Tg of the resin is the point at which essentially complete chemical reaction has been achieved. “Essentially complete” reaction of the resin has been achieved when no further reaction exotherm is observed by differential scanning calorimetry (DSC) upon heating of the resin.

U.S. Pat. No. 5,721,323 claims an epoxy resin compositions including about 0.3 to 1 parts per 100 parts of polyepoxide by weight of an imidazole catalyst and a Lewis acid curing inhibitor compound that is an oxide, hydroxide, or an alkoxide of zinc, titanium, cobalt, manganese, iron, silicon, boron or aluminum where the molar ratio of inhibitor:imidazole catalyst is between 0.6:1 and 3:1.

European Patent No. 0 729 484 B1 claims an epoxy resin composition including the concentration of 0.3 to 1 part per 100 parts of polyepoxide by weight of an imidazole catalyst and a cure inhibitor that is a halide, oxide, hydroxide, or alkoxide of zinc, tin, titanium, cobalt, manganese, iron, silicon, or aluminum or a boron oxide or alkoxide.

In light of the above, there is a need in the art for epoxy resin systems having improved properties and for prepregs having enhanced Tg and varnish gel times, for methods of preparing such resin systems and prepregs and for articles prepared therefrom.

### SUMMARY OF THE INVENTION

In one embodiment, the invention provides an epoxy resin composition which includes an epoxy resin, a curing agent, an accelerator compound, and at least one boron atom containing compound represented by the formula:

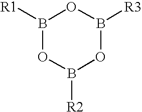

wherein each of R1, R2 and R3 is independently selected from the group consisting of hydrogen, a hydroxy group, an alkyl group, an aryl group, a cycloalkyl group, an alkoxy group, a cycloalkoxy group, an acyl, and an acyloxy group; wherein the accelerator is an imidazole group containing compound; and wherein the molar ratio of boron atom containing compound to accelerator is less than 0.55:1.

In another embodiment, the invention provides an epoxy resin composition which includes an epoxy resin, a curing agent, an accelerator compound, and at least one boron atom containing compound provided however that the accelerator does not contain an imidazole group.

In another embodiment the invention provides an epoxy resin composition which includes an epoxy resin, a curing agent, an accelerator compound, and at least one boron atom containing compound selected from ammonium biborate, ammonium biborate tetrahydrate, ammonium pentaborate, ammonium pentaborate octahydrate, lithium tetraborate, lithium tetraborate pentahydrate, sodium tetraborate, sodium tetraborate pentahydrate, sodium tetraborate decahydrate, sodium pentaborate octahydrate, disodium octaborate tetrahydrate, potassium tetraborate, potassium tetraborate tetrahydrate, potassium tetraborate pentahydrate, potassium pentaborate, potassium pentaborate tetrahydrate, potassium pentaborate octahydrate, dipotassium tetraborate tetrahydrate, dipotassium octaborate tetrahydrate, zinc octaborate, and combinations thereof.

In another embodiment the invention provides an epoxy resin composition which includes an epoxy resin, a curing agent, an accelerator compound, and at least one boron atom containing compound selected from boron hydrides, substituted or unsubstituted metaborates, substituted or unsubstituted polyborates, substituted or unsubstituted borazines, substituted or unsubstituted borazocines, substituted or unsubstituted borthiins, substituted or unsubstituted borphosphines, and combinations thereof.

In another embodiment prepregs, which include the epoxy resin compositions of the invention, are disclosed.

### BRIEF DESCRIPTION OF THE DRAWINGS

FIG. 1A is a graphical representation of the impact of cure time on Tg for resin system 6-1 in Table 8.

FIG. 1B is a graphical representation of the impact of cure time on Tg for resin system 6-2 in Table 8.

FIG. 1C is a graphical representation of the impact of cure time on Tg for resin system 6-3 in Table 8.

FIG. 2A is a is a graphical representation of the impact of cure time on Tg for resin system 6-4 in Table 9

FIG. 2B is a is a graphical representation of the impact of cure time on Tg for resin system 6-5 in Table 9

FIG. 2C is a is a graphical representation of the impact of cure time on Tg for resin system 6-6 in Table 9

### DETAILED DESCRIPTION OF THE INVENTION

The epoxy resin composition of the present invention includes at least one epoxy resin component, at least one curing agent, at least one accelerator, and at least one boron atom containing compound.

A. Epoxy Resin Component

The epoxy resin compositions of the invention include at least one epoxy resin component. Epoxy resins are those compounds containing at least one vicinal epoxy group. The epoxy resin may be saturated or unsaturated, aliphatic, cycloaliphatic, aromatic or heterocyclic and may be substituted. The epoxy resin may also be monomeric or polymeric.

The epoxy resin compound utilized may be, for example, an epoxy resin or a combination of epoxy resins prepared from an epihalohydrin and a phenol or a phenol type compound, prepared from an epihalohydrin and an amine, prepared from an epihalohydrin and an a carboxylic acid, or prepared from the oxidation of unsaturated compounds.

In one embodiment, the epoxy resins utilized in the compositions of the present invention include those resins produced from an epihalohydrin and a phenol or a phenol type compound. The phenol type compound includes compounds having an average of more than one aromatic hydroxyl group per molecule. Examples of phenol type compounds include dihydroxy phenols, biphenols, bisphenols, halogenated biphenols, halogenated bisphenols, hydrogenated bisphenols, alkylated biphenols, alkylated bisphenols, trisphenols, phenol-aldehyde resins, novolac resins (i.e. the reaction product of phenols and simple aldehydes, preferably formaldehyde), halogenated phenol-aldehyde novolac resins, substituted phenol-aldehyde novolac resins, phenol-hydrocarbon resins, substituted phenol-hydrocarbon resins, phenol-hydroxybenzaldehyde resins, alkylated phenol-hydroxybenzaldehyde resins, hydrocarbon-phenol resins, hydrocarbon-halogenated phenol resins, hydrocarbon-alkylated phenol resins, or combinations thereof.

In another embodiment, the epoxy resins utilized in the compositions of the invention preferably include those resins produced from an epihalohydrin and bisphenols, halogenated bisphenols, hydrogenated bisphenols, novolac resins, and polyalkylene glycols, or combinations thereof.

In another embodiment, the epoxy resin compounds utilized in the compositions of the invention preferably include those resins produced from an epihalohydrin and resorcinol, catechol, hydroquinone, biphenol, bisphenol A, bisphenol AP (1,1-bis(4-hydroxyphenyl)-1-phenyl ethane), bisphenol F, bisphenol K, tetrabromobisphenol A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, dicyclopentadiene-substituted phenol resins tetramethylbiphenol, tetramethyl-tetrabromobiphenol, tetramethyltribromobiphenol, tetrachlorobisphenol A, or combinations thereof.

The preparation of such compounds is well known in the art. See Kirk-Othmer, Encyclopedia of Chemical Technology, 3rd Ed., Vol. 9, pp 267-289. Examples of epoxy resins and their precursors suitable for use in the compositions of the invention are also described, for example, in U.S. Pat. Nos. 5,137,990 and 6,451,898 which are incorporated herein by reference.

In another embodiment, the epoxy resins utilized in the compositions of the present invention include those resins produced from an epihalohydrin and an amine. Suitable amines include diaminodiphenylmethane, aminophenol, xylene diamine, anilines, and the like, or combinations thereof.

In another embodiment, the epoxy resin utilized in the compositions of the present invention include those resins produced from an epihalohydrin and a carboxylic acid. Suitable carboxylic acids include phthalic acid, isophthalic acid, terephthalic acid, tetrahydro- and/or hexahydrophthalic acid, endomethylenetetrahydrophthalic acid, isophthalic acid, methylhexahydrophthalic acid, and the like or combinations thereof.

In another embodiment, the epoxy resin compounds utilized in the compositions of the invention include those resins produced from an epihalohydrin and compounds having at least one aliphatic hydroxyl group. In this embodiment, it is understood that such resin compositions produced contain an average of more than one aliphatic hydroxyl groups. Examples of compounds having at least one aliphatic hydroxyl group per molecule include aliphatic alcohols, aliphatic diols, polyether diols, polyether triols, polyether tetrols, any combination thereof and the like. Also suitable are the alkylene oxide adducts of compounds containing at least one aromatic hydroxyl group. In this embodiment, it is understood that such resin compositions produced contain an average of more than one aromatic hydroxyl groups. Examples of oxide adducts of compounds containing at least one aromatic hydroxyl group per molecule include ethylene oxide, propylene oxide, or butylene oxide adducts of dihydroxy phenols, biphenols, bisphenols, halogenated bisphenols, alkylated bisphenols, trisphenols, phenol-aldehyde novolac resins, halogenated phenol-aldehyde novolac resins, alkylated phenol-aldehyde novolac resins, hydrocarbon-phenol resins, hydrocarbon-halogenated phenol resins, or hydrocarbon-alkylated phenol resins, or combinations thereof.

In another embodiment the epoxy resin refers to an advanced epoxy resin which is the reaction product of one or more epoxy resins components, as described above, with one or more phenol type compounds and/or one or more compounds having an average of more than one aliphatic hydroxyl group per molecule as described above. Alternatively, the epoxy resin may be reacted with a carboxyl substituted hydrocarbon. A carboxyl substituted hydrocarbon which is described herein as a compound having a hydrocarbon backbone, preferably a C₁-C₄₀ hydrocarbon backbone, and one or more carboxyl moieties, preferably more than one, and most preferably two. The C₁-C₄₀ hydrocarbon backbone may be a straight- or branched-chain alkane or alkene, optionally containing oxygen. Fatty acids and fatty acid dimers are among the useful carboxylic acid substituted hydrocarbons. Included in the fatty acids are caproic acid, caprylic acid, capric acid, octanoic acid, VERSATIC acids, available from Resolution Performance Products LLC, Houston, Tex., decanoic acid, lauric acid, myristic acid, palmitic acid, stearic acid, palmitoleic acid, oleic acid, linoleic acid, linolenic acid, erucic acid, pentadecanoic acid, margaric acid, arachidic acid, and dimers thereof.

In another embodiment, the epoxy resin is the reaction product of a polyepoxide and a compound containing more than one isocyanate moiety or a polyisocyanate. Preferably the epoxy resin produced in such a reaction is an epoxy-terminated polyoxazolidone.

B. Curing Agents

In one embodiment, the curing agents utilized in the compositions of the invention include amine- and amide-containing curing agents having, on average, more than one active hydrogen atom, wherein the active hydrogen atoms may be bonded to the same nitrogen atom or to different nitrogen atoms. Examples of suitable curing agents include those compounds that contain a primary amine moiety, and compounds that contain two or more primary or secondary amine or amide moieties linked to a common central organic moiety. Examples of suitable amine-containing curing agents include ethylene diamine, diethylene triamine, polyoxypropylene diamine, triethylene tetramine, dicyandiamide, melamine, cyclohexylamine, benzylamine, diethylaniline, methylenedianiline, m-phenylenediamine, diaminodiphenylsulfone, 2,4 bis(p-aminobenzyl)aniline, piperidine, N,N-diethyl-1,3-propane diamine, and the like, and soluble adducts of amines and polyepoxides and their salts, such as described in U.S. Pat. Nos. 2,651,589 and 2,640,037.

In another embodiment, polyamidoamines may be utilized as a curing agent in the resin compositions of the invention. Polyamidoamines are typically the reaction product of a polyacid and an amine. Examples of polyacids used in making these polyamidoamines include 1,10-decanedioic acid, 1,12-dodecanedioic acid, 1,20-eicosanedioic acid, 1,14-tetradecanedioic acid, 1,18-octadecanedioic acid and dimerized and trimerized fatty acids. Amines used in making the polyamidoamines include aliphatic and cycloaliphatic polyamines such as ethylene diamine, diethylene triamine, triethylene tetramine, tetraethylene pentamine, 1,4-diaminobutane, 1,3-diaminobutane, hexamethylene diamine, 3-(N-isopropylamino)propylamine and the like. In another embodiment, polyamides are those derived from the aliphatic polyamines containing no more than 12 carbon atoms and polymeric fatty acids obtained by dimerizing and/or trimerizing ethylenically unsaturated fatty acids containing up to 25 carbon atoms.

In another embodiment, the curing agents are aliphatic polyamines, polyglycoldiamines, polyoxypropylene diamines, polyoxypropylenetriamines, amidoamines, imidazoles, reactive polyamides, ketimines, araliphatic polyamines (i.e. xylylenediamine), cycloaliphatic amines (i.e. isophoronediamine or diaminocyclohexane), menthane diamine, 4,4-diamino-3,3-dimethyldicyclohexylmethane, heterocyclic amines (aminoethyl piperazine), aromatic polyamines (methylene dianiline), diamino diphenyl sulfone, mannich base, phenalkamine, N,N′,N″-tris(6-aminohexyl) melamine, and the like. In another embodiment, imidazoles, which may be utilized as an accelerator for a curing agent, may also be utilized as a curing agent.

In another embodiment, the curing agent is a phenolic curing agent which includes compounds having an average of one or more phenolic groups per molecule. Suitable phenol curing agents include include dihydroxy phenols, biphenols, bisphenols, halogenated biphenols, halogenated bisphenols, hydrogenated bisphenols, alkylated biphenols, alkylated bisphenols, trisphenols, phenol-aldehyde resins, phenol-aldehyde novolac resins, halogenated phenol-aldehyde novolac resins, substituted phenol-aldehyde novolac resins, phenol-hydrocarbon resins, substituted phenol-hydrocarbon resins, phenol-hydroxybenzaldehyde resins, alkylated phenol-hydroxybenzaldehyde resins, hydrocarbon-phenol resins, hydrocarbon-halogenated phenol resins, hydrocarbon-alkylated phenol resins, or combinations thereof. Preferably, the phenolic curing agent includes substituted or unsubstituted phenols, biphenols, bisphenols, novolacs or combinations thereof.

The ratio of curing agent to epoxy resin is preferably suitable to provide a fully cured resin. The amount of curing agent which may be present may vary depending upon the particular curing agent used (due to the cure chemistry and curing agent equivalent weight as is known in the art).

C. Accelerators

Accelerators useful in the compositions of the invention include those compounds which catalyze the reaction of the epoxy resin with the curing agent.

In one embodiment, the accelerators are compounds containing amine, phosphine, heterocyclic nitrogen, ammonium, phosphonium, arsonium or sulfonium moieties. More preferably, the accelerators are heterocyclic nitrogen and amine-containing compounds and even more preferably, the accelerators are heterocyclic nitrogen-containing compounds.

In another embodiment, the heterocyclic nitrogen-containing compounds useful as accelerators include heterocyclic secondary and tertiary amines or nitrogen-containing compounds such as, for example, imidazoles, imidazolidines, imidazolines, bicyclic amidines, oxazoles, thiazoles, pyridines, pyrazines, morpholines, pyridazines, pyrimidines, pyrrolidines, pyrazoles, quinoxalines, quinazolines, phthalazines, quinolines, purines, indazoles, indazolines, phenazines, phenarsazines, phenothiazines, pyrrolines, indolines, piperidines, piperazines, as well as quaternary ammonium, phosphonium, arsonium or stibonium, tertiary sulfonium, secondary iodonium, and other related “onium” salts or bases, tertiary phosphines, amine oxides, and combinations thereof. Imidazoles as utilized herein include imidazole, 1-methylimidazole, 2-methylimidazole, 4-methylimidazole, 2-ethylimidazole, 2-ethyl-4-methylimidazole, 2-phenylimidazole, 2-undecylimidazole, 1-benzyl-2-methylimidazole, 2-beptadecyl imidazole, 4,5-diphenylimidazole, 2-isopropylimidazole, 2,4-dimethyl imidazole, 2-phenyl-4-methylimidazole, 1-cyanoethyl-2-ethyl-4-methylimidazole and the like. Preferred imidazoles include 2-methylimidazole, 2-phenylimidazole and 2-ethyl-4-methylimidazole.

Imidazolines as utilized herein include 2-methyl-2-imidazoline, 2-phenyl-2-imidazoline, 2-undecylimidazoline, 2-heptadecylimidazoline, 2-isopropylimidazole, 2,4-dimethyl imidazoline, 2-phenyl-4-methylimidazoline, 2-ethylimidazoline, 2-isopropylimidazoline, 4,4-dimethyl-2-imidazoline, 2-benzyl-2-imidazoline, 2-phenyl-4-methylimidazoline and the like.

Among preferred tertiary amines that may be used as accelerators are those mono- or polyamines having an open chain or cyclic structure which have all of the amine hydrogen replaced by suitable substituents, such as hydrocarbon radicals, and preferably aliphatic, cycloaliphatic or aromatic radicals. Examples of these amines include, among others, methyl diethanolamine, triethylamine, tributylamine, benzyl-dimethylamine, tricyclohexyl amine, pyridine, quinoline, and the like. Preferred amines are the trialkyl and tricycloalkyl amines, such as triethylamine, tri(2,3-dimethylcyclohexyl)amine, and the alkyl dialkanol amines, such as methyl diethanolamine and the trialkanolamines such as triethanolamine. Weak tertiary amines, e.g., amines that in aqueous solutions give a pH less than 10, are particularly preferred. Especially preferred tertiary amine accelerators are benzyldimethylamine and tris-(dimethylaminomethyl) phenol.

In another embodiment, the accelerator is a reaction product between an epoxy resin and an imidazole where the accelerator averages more than one imidazole group per molecule.

D. Boron Atom Containing Compound

The composition of the invention contains at least one compound containing at least one, preferably more than one, and more preferably 3 or more boron atoms. The boron atom containing compound may be, for example, a boroxine, a metaborate, a boron hydride, a polyborate, a borazine, a borazocine, a borthiin, a borphosphine or combinations thereof. In another embodiment, the boron containing compound is a trialkylboroxine. In another embodiment, the boron atom containing compound is a metaborate, a boron hydride, a polyborate, a borazine, a borazocine, a borthiin, a borphosphine or combinations thereof.

In one embodiment, the boron atom containing compound is an unsubstituted or substituted boroxine. In another embodiment, the boron atom containing compound is a boroxine represented by Formula 1:

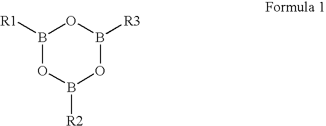

In Formula 1, each of R1, R2 and R3 is independently hydrogen, a hydroxy group, a hydrocarbyl group such as an alkyl, aryl, cycloalkyl, alkoxy, cycloalkoxy, acyl, or an acyloxy group, preferably containing 1 to 20 carbon atoms. Preferably, each of R1, R2 and R3 is an alkyl or an alkoxy group containing 1 to 20 carbon atoms, preferably less than 10, and more preferably less than 6 carbon atoms. In a most preferred embodiment, each of R1, R2 and R3 is an alkoxy group having 6 or fewer carbon atoms, preferably a butoxy, ethoxy, or methoxy group and most preferably a methoxy group. In another embodiment, each of R1, R2 and R3 is independently hydrogen, a hydroxy group, an alkyl, an aryl, a cycloalkyl, a cycloalkoxy, an acyl, or an acyloxy group containing 1 to 20 carbon atoms.

In another embodiment, in addition to the above, each of R1, R2 and R3 in Formula 1 may also independently be represented by R′O—, R′OO—, R′S—, R′₂N—, R′₂P—, and R′₃Si— where each R′ is hydrogen or a hydrocarbyl group, as described above, preferably containing 1 to 20 carbon atoms and more preferably 1 to 6 carbon atoms.

In a preferred embodiment each of R1, R2 and R3 represent an alkyl or alkoxy group and even more preferably the same alkyl or alkoxy group. Examples of suitable compounds represented by Formula 1 include trimethylboroxine, trimethoxyboroxine, 1-methyloxyboroxine, triethylboroxine, triethoxyboroxine, tri-n-propylboroxine, tributylboroxine, tricyclohexyloxyboroxine, tricyclohexylboroxine, triphenylboroxine, methyl diethylboroxine, dimethylethylboroxine and the like.

In one embodiment, the boron atom containing compound may be a substituted or unsubstituted metaborate. In another embodiment, the boron atom containing compound is a metaborate represented by Formula 2A or 2B.

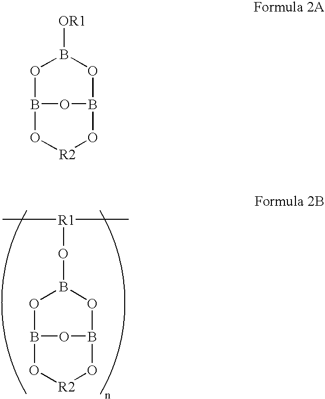

In Formula 2A, R1 is hydrogen, a hydrocarbyl group such as an alkyl, aryl, cycloalkyl, alkoxy, cycloalkoxy, acyl, or acyloxy group, preferably containing 1 to 20 carbon atoms. Preferably, R1 is an alkyl or an alkoxy group containing 1 to 20 carbon atoms, preferably less than 10 and more preferably 6 or fewer carbon atoms. n is an integer, preferably 1 to 5, and more preferably n is 2 or 3.

In Formula 2B, R1 is a hydrocarbyl group such as an alkyl, aryl, cycloalkyl, alkoxy, cycloalkoxy, acyl, or acyloxy group, preferably containing 1 to 20 carbon atoms. Preferably, R1 is an alkyl or an alkoxy group containing 1 to 20 carbon atoms, preferably less than 10 and more preferably less than 6 carbon atoms.

In Formulae 2A and 2B each R2 may be a hydrocarbyl group such as an alkyl, aryl, cycloalkyl, alkoxy, cycloalkoxy, acyl, or acyloxy group, preferably containing 1 to 20 carbon atoms and more preferably an alkyl or an alkoxy group containing 1 to 20 carbon atoms, preferably less than 10 and more preferably 6 or fewer carbon atoms.

In another embodiment, in addition to the above, each of R1 Formulae 2A and 2B may also independently be represented by R′O—, R′OO—, R′S—, R′₂N—, R′₂P—, and R′₃Si— where each R′ is hydrogen or a hydrocarbyl group, as described above, preferably containing 1 to 20 carbon atoms and more preferably containing 1 to 6 carbon atoms.

In one embodiment, the boron atom containing compound is a polyborate defined herein as an alkoxylated boron oxide matrix such as those compounds represented by Formula 3A, 3B and the like.

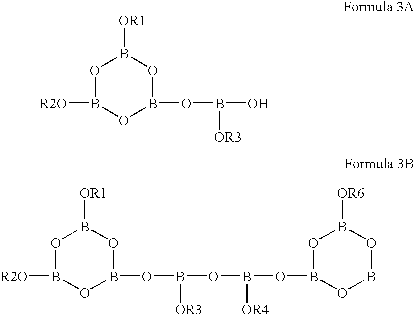

In Formula 3A, each of R1, R2 and R3 is independently hydrogen, a hydroxy group, a hydrocarbyl group such as an alkyl, aryl, cycloalkyl, alkoxy, cycloalkoxy, acyl, or acyloxy group, preferably containing 1 to 20 carbon atoms. Preferably, each of R1, R2 and R3 is an alkyl or an alkoxy group containing 1 to 20 carbon atoms, preferably less than 10, and more preferably less than 6 carbon atoms.

In Formula 3B, each of R1 to R6 is independently hydrogen, a hydroxy group, a hydrocarbyl group such as an alkyl, aryl, cycloalkyl, alkoxy, cycloalkoxy, acyl, or acyloxy group, preferably containing 1 to 20 carbon atoms. Preferably, each of R1, R2 and R3 is an alkyl or an alkoxy group containing 1 to 20 carbon atoms, preferably less than 10, and more preferably less than 6 carbon atoms.

In another embodiment, in addition to the above, each of R1 to R3 in Formula 3A and each of R1 to R6 in Formula 3B may also independently be represented by R′O—, R′OO—, R′S—, R′₂N—, R′₂P—, and R′₃Si— where each R′ is hydrogen or a hydrocarbyl group, as described above, preferably containing 1 to 20 carbon atoms and more preferably 1 to 6 carbon atoms.

In one embodiment, the boron atom containing compound is a boron hydride. Suitable examples of a boron hydride include, for example, tetraborane (B₄H₁₀), pentaborane (B₅H₉ or B₅H₁₁), hexaborane (B₆H₁₀), decaborane (B₁₀H₁₄), and combinations thereof.

In one embodiment, the boron atom containing compound is ammonium biborate, ammonium biborate tetrahydrate, ammonium pentaborate, ammonium pentaborate octahydrate, lithium tetraborate, lithium tetraborate pentahydrate, sodium tetraborate, sodium tetraborate pentahydrate, sodium tetraborate decahydrate, sodium pentaborate octahydrate, disodium octaborate tetrahydrate, potassium tetraborate, potassium tetraborate tetrahydrate, potassium tetraborate pentahydrate, potassium pentaborate, potassium pentaborate tetrahydrate, potassium pentaborate octahydrate, dipotassium tetraborate tetrahydrate, dipotassium octaborate tetrahydrate, zinc octaborate, and combinations thereof. In a preferred embodiment, the boron atom containing compound is ammonium pentaborate, ammonium pentaborate octahydrate, sodium tetraborate, sodium tetraborate decahydrate, potassium tetraborate, potassium tetraborate tetrahydrate, or combinations thereof.

In one embodiment, the boron atom containing compound is a substituted or unsubstituted borazine. In another embodiment, the boron atom containing compound is represented by Formula 4:

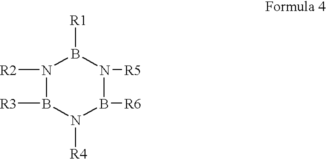

In Formula 4, each R1 to R6 is independently defined as hydrogen, a hydroxyl group, a hydrocarbyl group such as an alkyl, aryl, cycloalkyl, alkoxy, cycloalkoxy, acyl or acyloxy group, preferably containing 1 to 20 carbon atoms and more preferably containing 1 to 6 carbon atoms.

In another embodiment, in addition to the above, each of R1 to R6 in Formula 4 may also independently be represented by R′O—, R′S—, R′₂N—, R′₂P—, and R′₃Si— where each R′ is hydrogen or a hydrocarbyl group preferably containing 1 to 20 carbon atoms and more preferably containing 1 to 6 carbon atoms.

In one embodiment the boron atom containing compound is a substituted or unsubstituted borazocine. In another embodiment, the boron atom containing compound is represented by Formula 5.

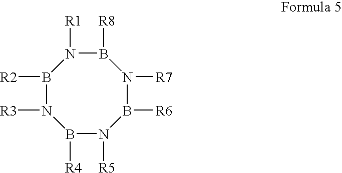

In Formula 5, each R1 to R8 is independently defined as hydrogen, a hydroxyl group, a hydrocarbyl group such as an alkyl, aryl, cycloalkyl, alkoxy, cycloalkoxy, acyl or acyloxy group, preferably containing 1 to 20 carbon atoms and more preferably containing 1 to 6 carbon atoms.

In another embodiment, in addition to the above, each of R1 to R8 in Formula 5 may also independently be represented by R′O—, R′S—, R′₂N—, R′₂P—, and R′₃Si— where each R′ is hydrogen or a hydrocarbyl group preferably containing 1 to 20 carbon atoms and more preferably containing 1 to 6 carbon atoms.

In one embodiment the boron atom containing compound is a substituted or unsubstituted borthiin. In another embodiment, the boron atom containing compound is represented by Formula 6.

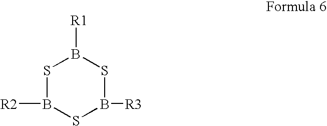

In Formula 6, each of R1, R2 and R3 are independently hydrogen, a hydroxy group, a hydrocarbyl group, such as an alkyl, aryl, cycloalkyl, alkoxy, cycloalkoxy, acyl, or acyloxy group, preferably containing 1 to 20 carbon atoms and more preferably containing 1 to 6 carbon atoms.

In another embodiment, in addition to the above, each of R1, R2 and R3 in Formula 6 may also independently be represented by R′O—, R′S—, R′₂N—, R′₂P—, and R′₃Si— where each R′ is hydrogen or a hydrocarbyl group preferably containing 1 to 20 carbon atoms and more preferably containing 1 to 6 carbon atoms.

In one embodiment the boron atom containing compound is a substituted or unsubstituted borophosphine. In another embodiment, the boron atom containing compound is represented by Formula 7:

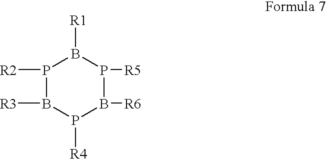

In Formula 7, each R1 to R6 is independently defined as hydrogen, a hydroxyl group, a hydrocarbyl group such as an alkyl, aryl, cycloalkyl, alkoxy, cycloalkoxy, acyl or acyloxy group, preferably containing 1 to 20 carbon atoms and more preferably containing 1 to 6 carbon atoms.

In another embodiment, in addition to the above, each of R1 to R6 in Formula 7 may also independently be represented by R′O—, R′S—, R′₂N—, R′₂P—, and R′₃Si— where each R′ is hydrogen or a hydrocarbyl group preferably containing 1 to 20 carbon atoms and more preferably containing 1 to 6 carbon atoms.

In another embodiment, two or more R groups contained in any of the boron atom containing compounds described above may be joined together to form a ring structure.

The boron containing compounds described above may be prepared from methods known in the art, such as, for example, those methods disclosed in: The Organic Chemistry of Boron, W. Gerrard, Academic Press 1961; Organoboron Chemistry, H. Steinberg, Interscience Publishing, vol. 1, 1964; and Organoboron Chemistry, H. Steinberg and Robert J. Brotherton, Interscience Publishing, vol. 2, 1966.

E. Resin Compositions

In one embodiment, the epoxy resin, curing agent, accelerator, and boron atom containing compound may be dissolved in a solvent. Preferably the concentration of solids in the solvent is at least about 50 percent and no more than about 80 percent solids. Suitable solvents include ketones, alcohols, glycol ethers, aromatic hydrocarbons and mixtures thereof. Preferred solvents include methyl ethyl ketone, methyl isobutyl ketone, propylene glycol methyl ether, ethylene glycol methyl ether, methyl amyl ketone, methanol, isopropanol, toluene, xylene, dimethylformamide and the like. A single solvent may be used, but in many applications a separate solvent is used for each component. Preferred solvents for the epoxy resins are ketones, including acetone, methylethyl ketone and the like. Preferred solvents for the curing agents include, for example ketones, amides such as dimethylformamide (DMF), ether alcohols such as methyl, ethyl, propyl or butyl ethers of ethylene glycol, diethylene glycol, propylene glycol or dipropylene glycol, ethylene glycol monomethyl ether, or 1-methoxy-2-propanol. The accelerators and boron atom containing compound, if not liquids, are preferably dissolved in, for example, ketones, glycol ethers and alcohols.

In one embodiment of the epoxy resin composition the boron containing compound is represented by Formula 1, preferably a trialkoxyboroxine and more preferably trimethoxyboroxine, the accelerator is an imidazole, preferably 1-methylimidazole, 2-methylimidazole, 4-methylimidazole, 2-ethylimidazole, 2-ethyl-4-methyl imidazole, 1-cyanoethyl-2-ethyl-4-methylimidazole or 2-phenylimidazole, more preferably 2-methylimidazole, 2-phenylimidazole and 2-ethyl-4-methyl imidazole, and most preferably 2-methylimidazole, and the molar ratio of boron atom containing compound to accelerator is between about 0.10:1 and about 0.55:1, preferably less than about 0.60:1, more preferably less than about 0.55:1, and even more preferably less than about 0.50:1. In another embodiment, and in addition to the above, the Tg of the fully cured resin composition is greater than that of comparative systems where the boron containing compound is not present. Preferably the resin composition when fully cured has a Tg of about 5° C., preferably 10° C., and more preferably 15° C. greater. In another embodiment, also in addition to the above, and referring to the FIGs, the resin composition exhibits a smaller change in the Tg (smaller ΔTg) during cure as compared to prior art formulations. Smaller changes indicate that the resin is more fully cured in the cure cycle thereby minimizing change in the resin during subsequent processing steps.

In another embodiment, the boron containing compound is represented by Formula 1, preferably a trialkoxyboroxine and more preferably trimethoxyboroxine, the accelerator is an imidazole, preferably 1-methylimidazole, 2-methylimidazole, 4-methylimidazole, 2-ethylimidazole, 2-ethyl-4-methyl imidazole, 1-cyanoethyl-2-ethyl-4-methylimidazole or 2-phenylimidazole, more preferably 2-methylimidazole, 2-phenylimidazole and 2-ethyl-4-methyl imidazole, and most preferably 2-methylimidazole, and the molar ratio of boron atom containing compound to accelerator is between about 0.10:1 and about 0.55:1, preferably less than about 0.60:1, more preferably less than about 0.55:1, and even more preferably less than about 0.50:1 and the varnish gel time is less than 250 seconds, preferably between 150 and 250 seconds and more preferably between 180 and 220 seconds.

In another embodiment, the boron containing compound is represented by Formula 1, preferably a trialkoxyboroxine and more preferably trimethoxyboroxine, the accelerator is an imidazole, preferably 1-methylimidazole, 2-methylimidazole, 4-methylimidazole, 2-ethylimidazole, 2-ethyl-4-methyl imidazole, 1-cyanoethyl-2-ethyl-4-methylimidazole or 2-phenylimidazole, more preferably 2-methylimidazole, 2-phenylimidazole and 2-ethyl-4-methyl imidazole and most preferably 2-methylimidazole, and the molar ratio of boron atom containing compound to accelerator is between about 0.10:1 and about 0.55:1, preferably less than about 0.60:1, more preferably less than about 0.55:1, and even more preferably less than about 0.50:1, the varnish gel time is less than 250 seconds, preferably between 150 and 250 seconds and more preferably between 180 and 220 seconds, and when compared to prior art formulations, both the Tg of the fully cured resin compositions is about 5° C., preferably 10° C., and more preferably 15° C. greater and the ΔTg is smaller.

In one embodiment of the resin composition, the boron containing compound is represented by Formula 1, and is preferably a trialkoxyboroxine, the accelerator is an imidazole, preferably 1-methylimidazole, 2-methylimidazole, 4-methylimidazole, 2-ethylimidazole, 2-ethyl-4-methyl imidazole, 1-cyanoethyl-2-ethyl-4-methylimidazole or 2-phenylimidazole, more preferably 2-methylimidazole, 2-phenylimidazole and 2-ethyl-4-methyl imidazole, and most preferably 2-methylimidazole, and the molar ratio of boron atom containing compound to accelerator is greater than 0.30:1, preferably greater than 0.35:1.

In another embodiment, the boron containing compound is represented by Formula 1 and is preferably a trialkylboroxine, and the accelerator is an imidazole, having an equivalent weight (i.e. the molecular weight divided by the number of imidazole functionality) of greater than 140 g/mol, preferably greater than 160 g/mol, preferably greater than 180 g/mol and more preferably greater than 200 g/mol. Suitable examples include 2-undecylimidazole as well as the reaction product of one of many epoxy resins and an imidazole such that the accelerator compound averages more than one imidazole group per molecule. In another embodiment, in addition, the imidazole is present at a weight ratio of greater than 1 part per hundred parts resin.

In another embodiment, the boron containing compound contains multiple Lewis acid functionality and/or the accelerator compound contains multiple basic functionality. In this embodiment, the equivalent weight of boron compound is defined as its molecular weight divided by number of Lewis acid functionality and the equivalent weight of accelerator compound is defined as the molecular weight divided by its number of basic functionality. The number of equivalents of the boron compound is equal to the amount of the boron compound utilized divided by its equivalent weight and the number of equivalents of the accelerator compound is equal to the weight of the accelerator compound divided by its equivalent weight. Ideally then, in this embodiment, the resin composition of the invention includes a ratio of equivalents of the boron compound to equivalents of accelerator compound of between about 0.4:1 to 3.0:1. Suitable examples of accelerator compounds containing multiple basic functionality include the reaction product of an epoxy resin and an imidazole such that the accelerator compound averages more than one imidazole group per molecule.

In another embodiment, the boron containing compound is represented by Formula 1 and the accelerator may be any accelerator for epoxy resin systems, except an imidazole or an imidazole group containing accelerator. In another embodiment, the accelerator is represented by such materials as imidazolidines, imidazolines, bicyclic amidines, oxazoles, thiazoles, pyridines, pyrazines, morpholines, pyridazines, pyrimidines, pyrrolidines, pyrazoles, quinoxalines, quinazolines, phthalazines, quinolines, purines, indazoles, indazolines, phenazines, phenarsazines, phenothiazines, pyrrolines, indolines, piperidines, piperazines and combinations thereof. In a preferred embodiment, the accelerator is tetramethylammonium hydroxide pentahydrate, triethylenediamine, or diazabicycloundecene (DBU).

The boron atom containing compound and accelerators may be added to the compositions of the invention separately or together.

The compositions of the invention may be impregnated upon a reinforcing material to make laminates, such as electrical laminates. The reinforcing materials which may be coated with the compositions of this invention include any material which would be used by the skilled artisan in formation of composites, prepregs, laminates and the like. Examples of appropriate substrates include fiber-containing materials such as woven cloth, mesh, mat, fibers, or the like. Preferably, such materials are made from glass or fiberglass, quartz, paper, polyethylene, poly(p-phenylene-terephthalamide), polyester, polytetrafluoroethylene, poly(p-phenylenebenzo-bisthiazole), carbon or graphite and the like. Preferred materials include glass or fiberglass, in woven cloth or mat form. The resin compositions of the invention may also include optional constituents such as inorganic fillers and additional flame retardants, for example antimony oxide, octabromodiphenyl oxide, decabromodiphenyl oxide, and other such constituents as is known in the art including, but not limited to, dyes, pigments, surfactants, flow control agents and the like.

Compositions containing the epoxy resins compositions of the invention may be contacted with an article used in any method known to those skilled in the art. Examples of such contacting methods include powder coating, spray coating, die coating, roll coating and contacting the article with a bath containing the composition. In a preferred embodiment the article is contacted with the composition in a bath.

In one embodiment, the reinforcing material is contacted with a bath comprising the epoxy resin composition of the invention dissolved and intimately admixed in a solvent or a mixture of solvents. The coating occurs under conditions such that the reinforcing material is coated with the epoxy resin composition. Thereafter the coated reinforcing materials are passed through a heated zone at a temperature sufficient to cause the solvents to evaporate, but below the temperature at which the resin composition undergoes significant cure during the residence time in the heated zone. The reinforcing material preferably has a residence time in the bath of from 1 second to 300 seconds, more preferably from 1 second to 120 seconds, and most preferably from 1 second to 30 seconds. The temperature of such bath is preferably from 0° C. to 100° C., more preferably from 10° C. to 40° C. and most preferably from 15° C. to 30° C. The residence time of the coated reinforcing material in the heated zone is from 0.1 to 15 min, more preferably from 0.5 to 10 min, and most preferably from 1 to 5 min. The temperature of such zone is sufficient to cause any solvents remaining to volatilize away yet not so high as to result in a complete curing of the components. Preferable temperatures of such zone are from 80° C. to 250° C., more preferably from 100° C. to 225° C., and most preferably from 150° C. to 210° C. Preferably there is a means in the heated zone to remove the solvent, either by passing an inert gas through the oven, or drawing a slight vacuum on the oven. In many embodiments the coated materials are exposed to zones of increasing temperature. The first zones are designed to cause the solvent to volatilize so it can be removed. The later zones are designed to result in partial cure of the polyepoxide (B-staging).

The catalysts utilized in the composition of the present invention are preferably latent at low temperatures, meaning that the curable resin will substantially stop curing after it is B-staged if the curable resin is cooled down, preferably to below 50° C. and more preferably to about room temperature (20° C. to 25° C.). The B-staged resin is then storage stable, preferably for at least about 10 days, more preferably for at least about 30 days, and most preferably for at least about 60 days. This makes it possible to interrupt curing of prepregs after B-staging, to ship or store the B-staged prepregs until they are needed, and to cure them to make laminates at a later time.

One or more sheets of prepreg are preferably processed into laminates optionally with one or more sheets of electrically-conductive material such as copper. In such further processing, one or more segments or parts of the coated reinforcing material are brought in contact with one another and/or the conductive material. Thereafter, the contacted parts are exposed to elevated pressures and temperatures sufficient to cause the epoxy resin to cure wherein the resin on adjacent parts react to form a continuous epoxy resin matrix between and about the reinforcing material. Before being cured the parts may be cut and stacked or folded and stacked into a part of desired shape and thickness. The pressures used can be anywhere from about 1 to about 1000 psi with from about 10 to about 800 psi being preferred. The temperature used to cure the resin in the parts or laminates, depends upon the particular residence time, pressure used, and resin used. Preferred temperatures which may be used are between about 100° C. and about 250° C., more preferably between about 120° C. and about 220° C., and most preferably between about 150° C. and about 190° C. The residence times are preferably from about 10 min to about 120 min, more preferably from about 20 to about 90 min, and most preferably from about 30 to about 50 min.

In one embodiment, the process is a continuous process where the reinforcing material is taken from the oven and appropriately arranged into the desired shape and thickness and pressed at very high temperatures for short times. In particular such high temperatures are from about 180° C. to about 250° C., more preferably about 190° C. to about 210° C., at times of about 1 to about 10 min and from about 2 to about 5 min. Such high speed pressing allows for the more efficient utilization of processing equipment. In such embodiments the preferred reinforcing material is a glass web or woven cloth.

In some embodiments it is desirable to subject the laminate or final product to a post cure outside of the press. This step is designed to complete the curing reaction. The post cure is usually performed at from 130° C. to 220° C. for from 20 to 200 minutes. This post cure step may be performed in a vacuum to remove any components which may volatilize.

In addition to high-performance electrical laminates, the resin compositions of the invention are useful for molding powders, coatings, and structural composite parts fabrication.

The epoxy resin compositions described herein may be found in various forms. In particular, the various compositions described may be found in powder form, hot melt, or alternatively in solution or dispersion. In those embodiments where the various compositions are in solution or dispersion, the various components of the composition may be dissolved or dispersed in the same solvent or may be separately dissolved in a solvent suitable for that component, then the various solutions are combined and mixed. In those embodiments wherein the compositions are partially cured or advanced, the compositions of this invention may be found in a powder form, solution form, or coated on a particular substrate.

In order to provide a better understanding of the present invention including representative advantages thereof, the following examples are offered.

### EXAMPLES

Formulations were prepared by dissolving the individual resin, curing agent, and accelerator components in suitable solvents at room temperature. Varnish gel times were measured with a hot plate at 171° C. using a test method similar to IPC-TM-650 Number 2.3.18. Prepregs were prepared by coating the accelerated resin varnish on style 7628 glass cloth and drying in a laboratory convection oven at 163° C. for 2-10 minutes to evaporate the solvents and advance the reacting epoxy/curing agent mixture to a non-tacky B-stage.

In most cases, laminates were prepared using 2 to 8 prepreg plies sandwiched between copper foil layers and pressing at 100 psi with the following cure cycle: (1) heat from room temperature to 350° F. at 10° F./min, (2) hold for 60 minutes at 350° F., and (3) cool at 20° F./min from 350° F. to 100° F. Prepreg resin flow during lamination was calculated as the percent laminate weight decrease due to the flow of resin out the laminate edge, similar to IPC-TM-650 Number 2.3.17. Laminate glass transition temperatures were measured by differential scanning calorimetry (DSC) at a heating rate of 20° C./min.

A number of different formulations were tested to verify the performance increase provided by the invention and these systems are summarized by the following examples. While several different resin and curing agent types were screened to demonstrate the invention, the systems listed here are not all inclusive of the resin and curing agent types that should show increased performance with the invention.

### Example 1

For prepregs for electrical laminates and similar applications, prepreg manufacturers generally prefer to have resin/curing agent systems with varnish gel times between 150 and 250 seconds. Varnish gel times in this range generally provide a balance of a wide processing window and sufficiently fast processing. Systems with shorter varnish gel times, while generally providing fast processing, often are overly sensitive to processing conditions and difficult to control. Similarly, systems with longer varnish gel times that are generally easy to process, often do so at slower rates than desired.

A common approach to adjust gel times to achieve the desired reactivity and balance of processing ease and processing speed is to adjust the accelerator level. In some cases, this may not be a practical solution. One example is those systems that are highly reactive such that gel times are very short even at low accelerator levels. For these systems, further reduction in accelerator level may not be feasible due to loss of process control, loss of cured system performance, or other reasons. However, it is well known in the art that a suitable acid, such as trimethoxyboroxine (TMBX), can be used in the formulation to essentially neutralize a portion of the basic accelerator, lengthen the varnish gel time, and achieve the desired varnish reactivity. The use of a conventional imidazole accelerator and TMBX to adjust varnish reactivity is demonstrated by the following formulation: 117.6 parts by weight (pbw) of an 85% solution of a high Tg, brominated epoxy resin (an epoxy-terminated polymer with oxazolidone, bisphenol A, and tetrabromobisphenol A backbone character), 3.5 parts dicyandiamide (Dicy), 31.5 parts N,N-dimethylformamide, 6.0 parts acetone, 0.9 to 5.0 parts propylene glycol monomethyl ether, and 2-methylimidazole and TMBX amounts as listed in Table 1.

TABLE 1
Effects of Accelerator and TMBX Levels on Varnish Gel Times

| System | Comp. 1-1 | Comp. 1-2 | Comp. 1-3 | Comp. 1-4 | Comp. 1-5 | 1-6 | 1-7 | 1-8 | 1-9 |
|---|---|---|---|---|---|---|---|---|---|
| 2-MI (pbw) | 0.10 | 0.14 | 0.18 | 0.30 | 0.45 | 0.45 | 0.45 | 0.45 | 0.45 |
| TMBX (pbw) | — | — | — | — | — | 0.31 | 0.39 | 0.46 | 0.56 |
| Varnish Gel Time | 209 | 170 | 152 | 99 | 79 | 200 | 229 | 231 | 250 |
| (seconds at 171° C.) | | | | | | | | | |
| TMBX:2-MI Molar | — | — | — | — | — | 0.32:1 | 0.40:1 | 0.49:1 | 0.58:1 |
| Ratio | | | | | | | | | |

### Example 2

A nominal 170° C. Tg, brominated epoxy laminating resin (an epoxy-terminated polymer with oxazolidone, bisphenol A, and tetrabromobisphenol A backbone character) that is typically cured with Dicy and accelerated with an imidazole compound was evaluated with TMBX. The data in Table 2 demonstrate that TMBX, in combination with higher accelerator levels, provides similar processing characteristics (varnish gel time, prepreg oven time, and resin flow) and significantly increases the glass transition temperature of the cured material above that for resin cured without TMBX.

TABLE 2
Effects of TMBX on High Tg Brominated Resin Performance

| | Component* | | | | |
|---|---|---|---|---|---|
| | Comp. 2-1 | Comp. 2-2 | Comp. 2-3 | 2-4 | Comp. 2-5 |
| Brominated epoxy resin, 85% in acetone | 117.6 | 117.6 | 117.7 | 117.7 | 117.6 |
| Dicyandiamide (Dicy) | 3.5 | 3.5 | 3.5 | 3.5 | 3.38 |
| Trimethoxyboroxine (TMBX) | — | — | 0.46 | 0.46 | 1.40 |
| 2-Methylimidazole (2-MI) | 0.14 | 0.40 | 0.14 | 0.45 | 0.56 |
| Acetone | 7.0 | 7.1 | 6.0 | — | — |
| N,N-Dimethylformamide (DMF) | 31.5 | 31.6 | 31.5 | 31.5 | 31.5 |
| Propylene Glycol Monomethyl Ether (PGME) | 1.3 | 3.6 | 1.3 | 4.1 | 5.1 |
| Property | | | | | |
| TMBX:2-MI Molar Ratio | — | — | 1.55:1 | 0.48:1 | 1.18:1 |
| Varnish Gel Time (seconds at 171° C.) | 207 | 89 | 344 | 202 | 280 |
| Prepreg Oven Time (minutes at 163° C.) | 4.5 | 3.0 | 9.0 | 5.1 | 6.5 |
| Prepreg Resin Flow (% wt.) | 17 | 0.3 | 15 | 12 | 16 |
| Laminate Tg (° C.) | 168 | 171 | 178 | 180 | 185 |

*Component values are parts by weight

System 2-2 shows that simply increasing the accelerator level not only results in undesirable processing conditions (gel time, oven time, and resin flow), but also laminate Tg is not significantly increased. System 2-3 shows that adding TMBX to the standard formulation (System 2-1) gives the desired Tg increase, but does not provide the desired processing conditions (gel time and oven time). However, by appropriate addition of TMBX and accelerator (System 2-4), higher Tg values can be obtained while maintaining the desired processing conditions. System 2-5, a formulation taught by U.S. Pat. No. 5,721,323 (Example 90), provides the desired Tg increase, but processing conditions are significantly different than desired as this system has long gel times and requires a longer oven or B-stage time to achieve the desired level of advancement or resin flow.

### Example 3

The data in Tables 3 through 5 further demonstrate the performance advantage provided by TMBX for a variety of formulations similar to those discussed in Example 2 and covering a range of Dicy, 2-MI, and TMBX levels. For most of the formulations, imidazole levels were adjusted to achieve approximate varnish gel times of 200 seconds, oven times of five minutes, and resin flow of 12-16% as preferred for processing. For the data in Tables 3 through 5, System 2-1 is the comparative formulation.

TABLE 3
Effects of TMBX on High Tg Brominated Resin Performance
at Lower Dicy Levels

| | 3-1 | 3-2 | 3-3 |
|---|---|---|---|
| Component* | | | |
| Brominated epoxy resin, 85% in acetone | 117.7 | 117.7 | 117.7 |
| Dicyandiamide (Dicy) | 2.5 | 2.7 | 2.7 |
| Trimethoxyboroxine (TMBX) | 0.43 | 0.63 | 0.64 |
| 2-Methylimidazole (2-MI) | 0.62 | 0.73 | 0.55 |
| Acetone | 1.8 | — | — |
| N,N-Dimethylformamide (DMF) | 22.8 | 24.3 | 24.3 |
| Propylene Glycol Monomethyl Ether | 5.6 | 6.5 | 5.0 |
| (PGME) | | | |
| Property | | | |
| TMBX:2-MI Molar Ratio | 0.33:1 | 0.41:1 | 0.55:1 |
| Varnish Gel Time (seconds at 171° C.) | 203 | 203 | 260-290 |
| Prepreg Oven Time (minutes at 163° C.) | 5.1 | 5.1 | 6.3 |
| Prepreg Resin Flow (% wt.) | 14 | 16 | 15 |
| Laminate Tg (° C.) | 174 | 180 | 180 |

*Component values are parts by weight

TABLE 4
Effects of TMBX on High Tg Brominated Resin Performance
at Medium Dicy Levels

| | 3-4 | 3-5 | 3-6 |
|---|---|---|---|
| Component* | | | |
| Brominated epoxy resin, 85% in acetone | 117.7 | 117.7 | 117.7 |
| Dicyandiamide (Dicy) | 3.1 | 3.1 | 3.1 |
| Trimethoxyboroxine (TMBX) | 0.46 | 0.43 | 0.73 |
| 2-Methylimidazole (2-MI) | 0.57 | 0.37 | 0.67 |
| Acetone | 0-1.0 | — | 1.8 |
| N,N-Dimethylformamide (DMF) | 27.9 | 27.9 | 27.9 |
| Propylene Glycol Monomethyl Ether | 5.2 | 3.4 | 6.1 |
| (PGME) | | | |
| Property | | | |
| TMBX:2-MI Molar Ratio | 0.38:1 | 0.55:1 | 0.51:1 |
| Varnish Gel Time (seconds at 171° C.) | 197 | 260-310 | 205 |
| Prepreg Oven Time (minutes at 163° C.) | 5.1 | 6.3 | 5.1 |
| Prepreg Resin Flow (% wt.) | 14 | 14 | 14 |
| Laminate Tg (° C.) | 178 | 176 | 183 |

*Component values are parts by weight

TABLE 5
Effects of TMBX on High Tg Brominated Resin Performance
at Higher Dicy Levels

| | 3-7 | 3-8 | 3-9 |
|---|---|---|---|
| Component* | | | |
| Brominated epoxy resin, 85% in acetone | 117.8 | 117.7 | 117.7 |
| Dicyandiamide (Dicy) | 3.5 | 3.5 | 3.7 |
| Trimethoxyboroxine (TMBX) | 0.23 | 0.67 | 0.43 |
| 2-Methylimidazole (2-MI) | 0.30 | 0.57 | 0.42 |
| Acetone | 0.9 | — | — |
| N,N-Dimethylformamide (DMF) | 31.5 | 31.5 | 33.0 |
| Propylene Glycol Monomethyl Ether | 2.7 | 5.1 | 3.8 |
| (PGME) | | | |
| Property | | | |
| TMBX:2-MI Molar Ratio | 0.36:1 | 0.56:1 | 0.48:1 |
| Varnish Gel Time (seconds at 171° C.) | 202 | 202 | 207 |
| Prepreg Oven Time (minutes at 163° C.) | 5.1 | 5.1 | 5.1 |
| Prepreg Resin Flow (% wt.) | 13 | 16 | 13 |
| Laminate Tg (° C.) | 171 | 177 | 176 |

*Component values are parts by weight

### Example 4

TMBX is utilized with a conventional brominated epoxy resin (the reaction product of diglycidyl ether of bisphenol A and tetrabromobisphenol A), such as EPON Resin 1124-A-80 available from Resolution Performance Products LLC, Houston, Tex., that is typically cured with Dicy and accelerated with an imidazole compound. As shown in Table 6, TMBX, in combination with a higher accelerator level, provides similar processing characteristics (varnish gel time, prepreg oven time, and resin flow) and significantly increases the glass transition temperature of the cured material above that for resin cured without TMBX. The performance and processing characteristics are also shown in Table 6 for a similar varnish formulation that includes 4 phr (solids basis) of a tetrafunctional epoxy resin.

TABLE 6
Effects of TMBX on Brominated Epoxy Resin Performance

| | Comp. | | |
|---|---|---|---|
| | 4-1 | 4-2 | 4-3 |
| Component* | | | |
| Brominated epoxy resin, 80% in acetone | 125.0 | 125.0 | 125.0 |
| Tetrafunctional epoxy resin, 70% in acetone | — | — | 5.7 |
| Dicyandiamide (Dicy) | 3.0 | 3.0 | 2.7 |
| Trimethoxyboroxine (TMBX) | — | 0.46 | 0.45 |
| 2-Methylimidazole (2-MI) | 0.10 | 0.56 | 0.44 |
| Acetone | 12.0 | 12.0 | 6.0 |
| N,N-Dimethylformamide (DMF) | 27.0 | 27.0 | 24.3 |
| Propylene Glycol Monomethyl Ether | 0.9 | 5.0 | 8.3 |
| (PGME) | | | |
| Property | | | |
| TMBX:2-MI Molar Ratio | — | 0.39:1 | 0.48:1 |
| Varnish Gel Time (seconds at 171° C.) | 175 | 163 | 187 |
| Prepreg Oven Time (minutes at 163° C.) | 3.8 | 3.8 | 4.5 |
| Prepreg Resin Flow (% wt.) | 13 | 9 | 14 |
| Laminate Tg(° C.) | 135 | 141 | 147 |

*Component values are parts by weight

### Example 5

TMBX can also be used with epoxy formulations that are cured with materials other than dicyandiamide. To demonstrate this approach, a high Tg, phenolic-cured brominated laminating system (consisting of 54.3 percent by weight epoxy resin and 25 percent by weight MEK) was screened with TMBX. For this system, which has the curing agent blended with the epoxy resin, cure is obtained with the application of heat and the addition of an accelerator such as an imidazole compound to control reaction rate. As shown in Table 7, using TMBX in combination with a higher accelerator level provides similar processing characteristics (varnish gel time, prepreg oven time, and resin flow) and significantly increases the glass transition temperature of the cured material above that for resin cured without TMBX; thus, demonstrating the performance benefits of TMBX with a resin system that is not cured with Dicy.

TABLE 7
Effects of TMBX on the Performance of a High Tg,
Phenolic-Cured System

| | Comp. 5-1 | 5-2 |
|---|---|---|
| Component* | | |
| High Tg, phenolic cured brominated system, 75% | 133.4 | 133.3 |
| solids in MEK | | |
| Trimethoxyboroxine (TMBX) | — | 0.45 |
| 2-Methylimidazole (2-MI) | 0.10 | 0.38 |
| Propylene Glycol Monomethyl Ether (PGME) | 10.9 | 6.5 |
| Property | | |
| TMBX:2-MI Molar Ratio | — | 0.56:1 |
| Varnish Gel Time (seconds at 171° C.) | 102 | 110 |
| Prepreg Oven Time (minutes at 163° C.) | 3.0 | 3.0 |
| Prepreg Resin Flow (% wt.) | 18 | 14 |
| Laminate Tg (° C.) | 162 | 179 |

*Component values are parts hy weight

### Example 6

To demonstrate the fast cure capabilities of epoxy systems formulated with TMBX, prepregs were prepared in the manner previously described and then cured in a convection oven. Here, the prepregs were heated in the oven from 25 to 175° C. over 20 minutes followed by a cure hold time of 20 to 60 minutes at 175° C. (347° F.). Two different Dicy-cured epoxy systems were studied: a conventional brominated epoxy system (as described for Example 4) and a high Tg brominated epoxy system (as described in Example 2), the data for which are provided in Tables 8 and 9, respectively. For this work, formulations 6-1 and 6-4 are comparatives representing standard formulations without TMBX, formulations 6-2 and 6-5 represent the compositions of the invention, and formulations 6-3 and 6-6 are representative of compositions taught by U.S. Pat. No. 5,721,323.

TABLE 8
Effects of TMBX on the Fast Cure Performance of a
Brominated Epoxy Resin

| | Comp. | | Comp. |
|---|---|---|---|
| | 6-1 | 6-2 | 6-3 |
| Component* | | | |
| Brominated epoxy resin, 80% in acetone | 125.0 | 125.0 | 125.0 |
| Dicyandiamide (Dicy) | 3.0 | 3.0 | 3.38 |
| Trimethoxyboroxine (TMBX) | — | 0.46 | 1.40 |
| 2-Methylimidazole (2-MI) | 0.10 | 0.56 | 0.56 |
| N,N-Dimethylformamide (DMF) | 27.0 | 27.0 | 30.4 |
| Propylene Glycol Monomethyl Ether | 10.9 | 12.0 | 10.1 |
| (PGME) | | | |
| Property | | | |
| TMBX:2-MI Molar Ratio | — | 0.39:1 | 1.18:1 |
| Varnish Gel Time (seconds at 171° C.) | 148 | 174 | 164 |
| Cured Prepreg Tg after 20 minutes at | | | |
| 175 ° C. | | | |
| Heat 1 (° C.) | 124 | 141 | 130 |
| Heat 2 (° C.) | 131 | 146 | 142 |
| Cured Prepreg Tg after 30 minutes at | | | |
| 175 ° C. | | | |
| Heat 1 (° C.) | 126 | 147 | 145 |
| Heat 2 (° C.) | 132 | 148 | 151 |
| Cured Prepreg Tg after 45 minutes at | | | |
| 175 ° C. | | | |
| Heat 1 (° C.) | 133 | 149 | 153 |
| Heat 2 (° C.) | 137 | 151 | 154 |
| Cured Prepreg Tg after 60 minutes at | | | |
| 175 ° C. | | | |
| Heat 1 (° C.) | 134 | 146 | 163 |
| Heat 2 (° C.) | 140 | 148 | 161 |

*Component values are parts by weight

TABLE 9
Effects of TMBX on Fast Cure Performance of a High Tg
Brominated Epoxy Resin

| | Comp. | | Comp. |
|---|---|---|---|
| | 6-4 | 6-5 | 6-6 |
| Component* | | | |
| Brominated epoxy resin, 85% in acetone | 117.6 | 117.6 | 117.6 |
| Dicyandiamide (Dicy) | 3.5 | 3.5 | 3.38 |
| Trimethoxyboroxine (TMBX) | — | 0.46 | 1.40 |
| 2-Methylimidazole (2-MI) | 0.14 | 0.45 | 0.56 |
| N,N-Dimethylformamide (DMF) | 31.5 | 31.5 | 30.4 |
| Propylene Glycol Monomethyl Ether | 9.3 | 9.1 | 10.1 |
| (PGME) | | | |
| Property | | | |
| TMBX:2-MI Molar Ratio | — | 0.48:1 | 1.18:1 |
| Varnish Gel Time (seconds at 171° C.) | 172 | 222 | 261 |
| Cured Prepreg Tg after 30 minutes at | | | |
| 175 ° C. | | | |
| Heat 1 (° C.) | 149 | 160 | 141 |
| Heat 2 (° C.) | 159 | 173 | 173 |
| Cured Prepreg Tg after 45 minutes at | | | |
| 175° C. | | | |
| Heat 1 (° C.) | 162 | 176 | 165 |
| Heat 2 (° C.) | 165 | 178 | 183 |
| Cured Prepreg Tg after 60 minutes at | | | |
| 175° C. | | | |
| Heat 1 (° C.) | 168 | 177 | 176 |
| Heat 2 (° C.) | 169 | 180 | 185 |

*Component values are parts by weight

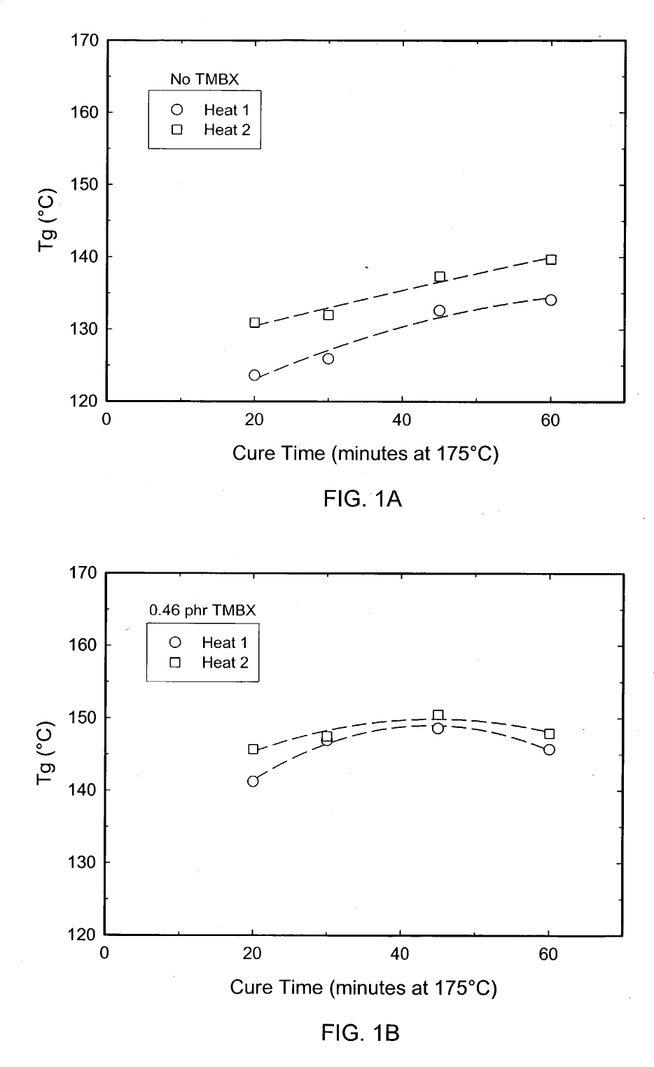

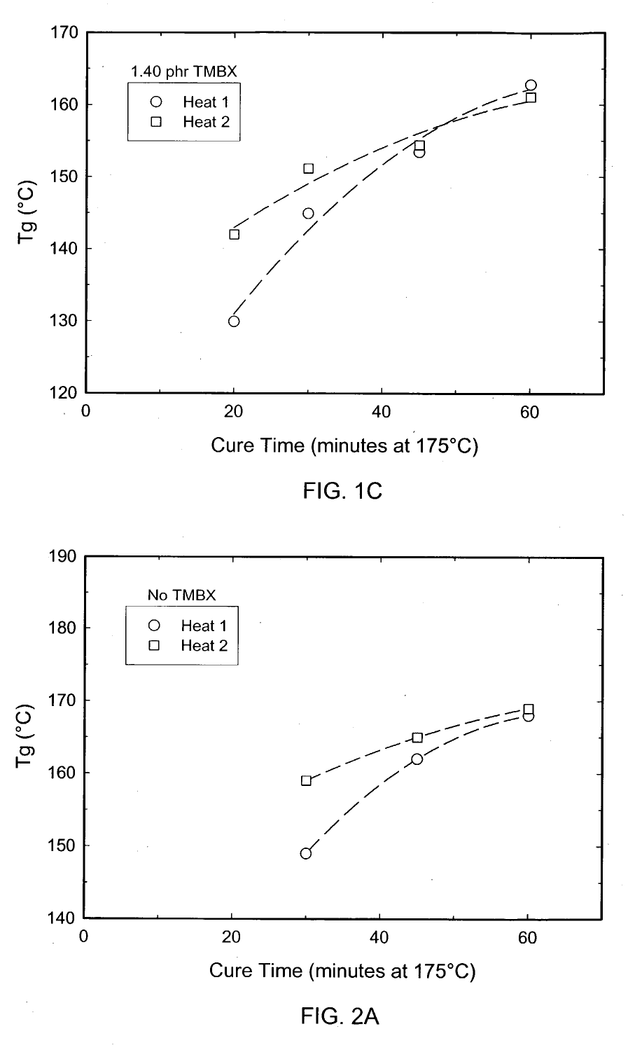

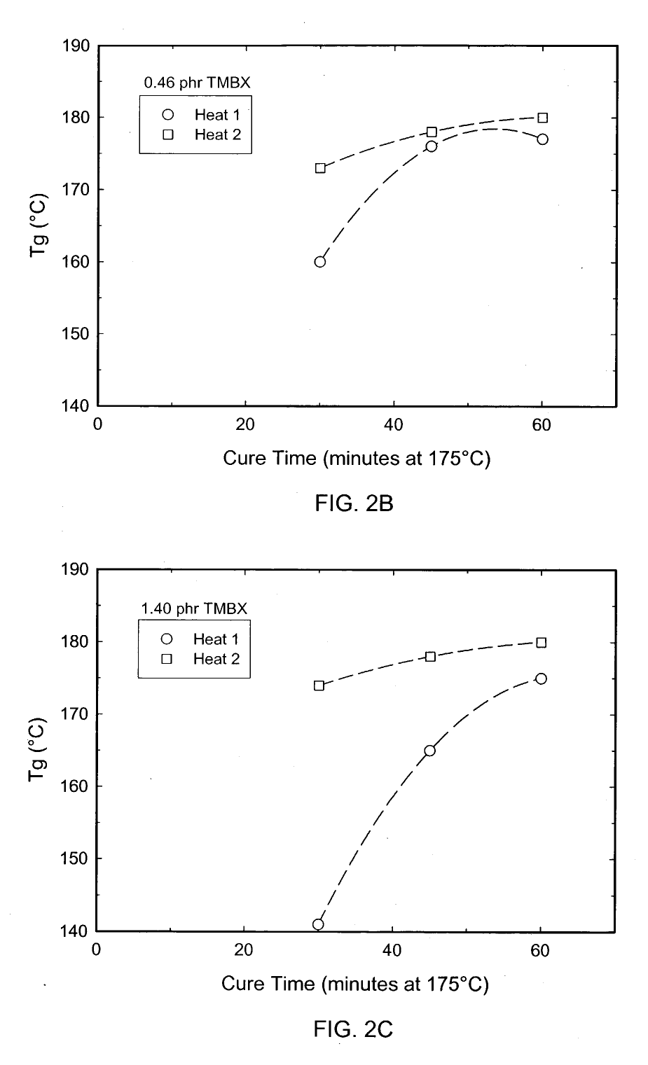

For a graphical representation of the data in Tables 8 and 9, please refer to FIGS. 1A-1C and 2A-2C, respectively. The data for formulations 6-2 and 6-5 show that higher Tg and lower delta Tg values are obtained with a shorter cure cycle than without TMBX (the control system). Delta Tg is the difference of heat 2 and heat 1 Tg values and represents a measure of the degree of cure of a system. In general, delta Tg values less than 2° C. suggest near full cure. Relative to the TMBX formulations taught by U.S. Pat. No. 5,721,323, the proposed formulations provides about the same Tg and lower delta Tg values, especially for shorter cure cycles.

### Example 7

The data in Tables 10 through 12 further demonstrate the performance advantage provided by TMBX when using a variety of accelerators that are representative of the wide range of available accelerators. The alternate accelerators evaluated include EPIKURE® Curing Agent P-101 (an imidazole adduct available from Resolution Performance Products LLC, Houston, Tex.), 2-undecylimidazole, tetramethylammonium hydroxide pentahydrate, 2-phenyl-2-imidazoline, triethylenediamine, and diazabicycloundecene. For this work, the high Tg resin described in Example 2 was formulated with Dicy, a wide range of accelerators, and with and without TMBX. Accelerator levels were adjusted to achieve approximate varnish gel times of 200 seconds, oven times of five minutes, and resin flow of 12-16% as preferred for processing.

TABLE 10
Effects of Alternate Accelerators on TMBX Performance

| | Comp. | | Comp. | |
|---|---|---|---|---|
| | 7-1 | 7-2 | 7-3 | 7-4 |
| Component* | | | | |
| Brominated epoxy resin, 85% in | 117.7 | 117.7 | 117.7 | 117.7 |
| acetone | | | | |
| Dicyandiamide (Dicy) | 3.0 | 3.0 | 3.0 | 3.0 |
| Trimethoxyboroxine (TMBX) | — | 0.45 | — | 0.45 |
| EPIKURE Curing Agent P-101 | 0.34 | 1.67 | — | — |
| 2-Undecylimidazole (2-UDI) | — | — | 0.33 | 1.34 |
| Acetone | 6.0 | — | 6.0 | — |
| N,N-Dimethylformamide (DMF) | 27.0 | 27.0 | 27.0 | 27.0 |
| Propylene Glycol Monomethyl | 1.3 | 6.7 | 3.0 | 12.0 |
| Ether (PGME) | | | | |
| Property | | | | |
| TMBX:Accelerator Molar Ratio | — | 0.84:1 | — | 0.43:1 |
| Varnish Gel Time (seconds at | 218 | 207 | 198 | 213 |
| 171° C.) | | | | |
| Prepreg Oven Time (minutes at | 5.0 | 5.0 | 4.75 | 5.0 |
| 163° C.) | | | | |
| Prepreg Resin Flow (% wt.) | 15 | 16 | 12 | 16 |
| Laminate Tg (° C.) | 159 | 177 | 163 | 173 |

*Component values are parts by weight

TABLE 11
Effects of Alternate Accelerators on TMBX Performance

| | Comp. | | Comp. | |
|---|---|---|---|---|
| | 7-5 | 7-6 | 7-7 | 7-8 |
| Component* | | | | |
| Brominated epoxy resin, 85% in | 117.7 | 117.7 | 117.7 | 117.7 |
| acetone | | | | |
| Dicyandiamide (Dicy) | 3.0 | 3.0 | 3.0 | 3.0 |
| Trimethoxyboroxine (TMBX) | — | 0.47 | — | 0.47 |
| Tetramethylammonium Hydroxide | 0.27 | 1.17 | — | — |
| Pentahydrate (TMAOH) | | | | |
| 2-Phenyl-2-Imidazoline (2-P-2-IZ) | — | — | 0.76 | 2.84 |
| Acetone | 6.1 | — | 6.0 | — |
| N,N-Dimethylformamide (DMF) | 27.0 | 27.0 | 27.0 | 27.0 |
| Propylene Glycol Monomethyl | 2.4 | 10.5 | 6.8 | 25.5 |
| Ether (PGME) | | | | |
| Property | | | | |
| TMBX:Accelerator Molar Ratio | — | 0.42:1 | — | 0.14:1 |
| Varnish Gel Time (seconds at | 205 | 220 | 205 | 202 |
| 171° C.) | | | | |
| Prepreg Oven Time (minutes at | 5.0 | 5.0 | 4.25 | 4.25 |
| 163° C.) | | | | |
| Prepreg Resin Flow (% wt.) | 16 | 16 | 16 | 12 |
| Laminate Tg (° C.) | 158 | 170 | 155 | 160 |

*Component values are parts by weight

TABLE 12
Effects of Alternate Accelerators on TMBX Performance

| | Comp. | | Comp. | |
|---|---|---|---|---|
| | 7-9 | 7-10 | 7-11 | 7-12 |
| Component* | | | | |
| Brominated epoxy resin, 85% | 117.7 | 117.7 | 117.7 | 117.7 |
| in acetone | | | | |
| Dicyandiamide (Dicy) | 3.0 | 3.0 | 3.0 | 3.0 |
| Trimethoxyboroxine (TMBX) | — | 0.45 | — | 0.47 |
| Triethylenediamine (Dabco ™) | 0.37 | 1.24 | — | — |
| Diazobicycloundecene (DBU) | — | — | 0.27 | 1.11 |
| Acetone | 6.0 | — | 6.0 | — |
| N,N-Dimethylformamide (DMF) | 27.0 | 27.0 | 27.0 | 27.0 |
| Propylene Glycol Monomethyl | 3.4 | 11.1 | 1.1 | 4.4 |
| Ether (PGME) | | | | |
| Property | | | | |
| TMBX:Accelerator Molar Ratio | — | 0.23 | — | 0.37 |
| Varnish Gel Time (seconds at | 197 | 202 | 196 | 215 |
| 171° C.) | | | | |
| Prepreg Oven Time (minutes at | 5.0 | 4.5 | 5.0 | 5.0 |
| 163° C.) | | | | |
| Prepreg Resin Flow (% wt.) | 11 | 10 | 14 | 15 |
| Laminate Tg (° C.) | 153 | 168 | 158 | 179 |

*Component values are parts by weight

As was the case with 2-methylimidazole, addition of TMBX to formulations with a range of alternate accelerators provided performance benefits as exhibited by Tg values that were 5-20° C. higher than similar formulations without TMBX.

### Example 8

Ammonium pentaborate octahydrate (formula weight of 544.3) was formulated with the high Tg resin described in Example 2, Dicy, and an imidazole accelerator as provided in Table 13. Table 13 also provides similar data for System 2-1, the comparable system without ammonium pentaborate octahydrate (APBO). As with TMBX, ammonium pentaborate octahydrate, when used in combination with higher accelerator levels, provides similar processing characteristics (varnish gel time, prepreg oven time, and resin flow) and significantly higher glass transition temperature for the cured material than that for resin cured without this additive.

TABLE 13
Effects of Ammonium Pentaborate on High Tg
Brominated Resin Performance

| | Component* | | |
|---|---|---|---|
| | Comp. 2-1 | 8-1 | 8-2 |
| Brominated epoxy resin, 85% in | 117.6 | 117.7 | 118.2 |
| acetone | | | |
| Dicyandiamide (Dicy) | 3.5 | 3.5 | 3.5 |
| Ammonium Pentaborate Octahydrate | — | 0.40 | 0.81 |
| (APBO) | | | |
| 2-Methylimidazole (2-MI) | 0.14 | 0.45 | 0.45 |
| Acetone | 7.0 | — | — |
| N,N-Dimethylformamide (DMF) | 31.5 | 31.5 | 31.5 |
| Propylene Glycol Monomethyl Ether | 1.3 | 4.1 | 4.1 |
| (PGME) | | | |
| Methanol (MeOH) | — | 2.13 | 4.25 |
| Property | | | |
| APBO:2-MI Molar Ratio | — | 0.13:1 | 0.27:1 |
| Varnish Gel Time (seconds | 207 | 193 | 250 |
| at 171° C.) | | | |
| Prepreg Oven Time (minutes | 4.5 | 5.0 | 5.5 |
| at 163° C.) | | | |
| Prepreg Resin Flow (% wt.) | 17 | 16 | 17 |
| Laminate Tg (° C.) | 168 | 175 | 180 |

*Component values are parts by weight

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

We claim:

1. An epoxy resin composition comprising an epoxy resin, a curing agent, an accelerator compound, and at least one boron atom containing compound represented by the formula: 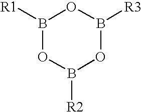
wherein each of R1, R2 and R3 is independently selected from the group consisting of hydrogen, a hydroxy group, an alkyl group, an aryl group, a cycloalkyl group, an alkoxy group, a cycloalkoxy group, an acyl, and an acyloxy group; wherein the accelerator is an imidazole group containing compound; and wherein the molar ratio of boron atom containing compound to accelerator is less than 0.55:1.

2. The epoxy resin composition of claim 1 wherein the concentration of the accelerator is greater than 1 part per 100 parts resin.

3. The epoxy resin composition of claim 1 wherein the accelerator compound is selected from the group consisting of imidazole, 1-methylimidazole, 2-methylimidazole, 4-methylimidazole, 2-ethylimidazole, 2-ethyl-4-methylimidazole, 2-phenylimidazole, 2-undecylimidazole, 1-benzyl-2-methylimidazole, 2-heptadecyl imidazole, 4,5-diphenylimidazole, 2-isopropylimidazole, 2,4-dimethyl imidazole, 2-phenyl-4-methylimidazole, 1-cyanoethyl-2-ethyl-4-methylimidazole and combinations thereof.

4. The epoxy resin composition of claim 1 wherein the accelerator compound is selected from the group consisting of 2-methylimidazole, 2-ethyl-4-methyl imidazole and 2-phenylimidazole.

5. The epoxy resin composition of claim 1 wherein the accelerator compound averages more than one imidazole functionality per molecule.

6. The epoxy resin composition of claim 1 wherein the accelerator compound is an imidazole having an equivalent weight of greater than 140 g/mol.

7. The epoxy resin composition of claim 1 wherein each of R1, R2 and R3 is independently an alkyl or an alkoxy group containing 1 to 20 carbon atoms.

8. The epoxy resin composition of claim 1 wherein the boron atom containing compound is selected from the group consisting of trimethylboroxine, trimethoxyboroxine, 1-methyloxyboroxine, triethylboroxine, triethoxyboroxine, tri-n-propylboroxine, tributylboroxine, tricyclohexyloxyboroxine, tricyclohexylboroxine, triphenylboroxine, methyl diethylboroxine, dimethylethylboroxine, and combinations thereof.

9. The epoxy resin composition of claim 1 wherein the resin composition is a fully cured composition having a Tg of about 5° C. greater than that of a comparable resin composition not including the boron atom containing compound.

10. The epoxy resin composition of claim 1 wherein the ΔTg is smaller than that of a comparable resin composition not including the boron atom containing compound.

11. An epoxy resin composition comprising an epoxy resin, a curing agent, an accelerator compound, and at least one boron atom containing compound represented by the formula: 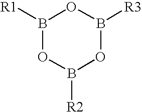
wherein each of R1, R2 and R3 is independently selected from the group consisting of hydrogen, a hydroxy group, an alkyl group, an aryl group, a cycloalkyl group, an alkoxy group, a cycloalkoxy group, an acyl group, and an acyloxy group;
provided however that the accelerator compound does not contain an imidazole group.

12. The epoxy resin system of claim 11 wherein the accelerator compound is selected from the group consisting of tertiary amines, imidazolidines, imidazolines, bicyclic amidines, oxazoles, thiazoles, pyridines, pyrazines, morpholines, pyridazines, pyrimidines, pyrrolidines, pyrazoles, quinoxalines, quinazolines, phthalazines, quinolines, purines, indazoles, indazolines, phenazines, phenarsazines, phenothiazines, pyrrolines, indolines, piperidines, piperazines, quaternary ammoniums, quaternary phosphoniums, quaternary arsoniums, quaternary stiboniums, tertiary sulfoniums, secondary iodoniums, tertiary phosphines, amine oxides, and combinations thereof.

13. The epoxy resin system of claim 11 wherein the accelerator compound is selected from the group consisting of tetramethylammonium hydroxide pentahydrate, triethylenediamine, and diazabicycloundecene.

14. A prepreg comprising the epoxy resin composition of claim 1.

15. A prepreg comprising the epoxy resin composition of claim 11.

16. An epoxy resin composition comprising an epoxy resin, a curing agent, an accelerator compound, and at least one boron atom containing compound selected from the group consisting of ammonium biborate, ammonium biborate tetrahydrate, ammonium pentaborate, ammonium pentaborate octahydrate, lithium tetraborate, lithium tetraborate pentahydrate, sodium tetraborate, sodium tetraborate pentahydrate, sodium tetraborate decahydrate, sodium pentaborate octahydrate, disodium octaborate tetrahydrate, potassium tetraborate, potassium tetraborate tetrahydrate, potassium tetraborate pentahydrate, potassium pentaborate, potassium pentaborate tetrahydrate, potassium pentaborate octahydrate, dipotassium tetraborate tetrahydrate, dipotassium octaborate tetrahydrate, zinc octaborate, and combinations thereof.

17. The epoxy resin composition of claim 16 wherein the boron atom containing compound selected from the group consisting of ammonium pentaborate, ammonium pentaborate octahydrate, sodium tetraborate, sodium tetraborate decahydrate, potassium tetraborate, potassium tetraborate tetrahydrate, and combinations thereof.

18. An epoxy resin composition comprising an epoxy resin, a curing agent, an accelerator compound, and at least one boron atom containing compound selected from the group consisting of boron hydrides, substituted or unsubstituted metaborates, substituted or unsubstituted polyborates, substituted or unsubstituted borazines, substituted or unsubstituted borazocines, substituted or unsubstituted borthiins, substituted or unsubstituted borphosphines, and combinations thereof.
